(19) United States
(12) Patent Application Publication
(10) Pub. No.: US 2014/0250442 A1
(43) Pub. Date: Sep. 4, 2014

(54) Conditional Notification Mechanism

(71) Applicant: ADVANCED MICRO DEVICES, INC, Sunnyvale, CA (US)

(72) Inventors: Steven K. Reinhardt, Vancouver, WA (US); Marc S. Orr, Renton, WA (US); Bradford M. Beckmann, Redmond, WA (US)

(73) Assignee: Advanced Micro Devices, Inc., Sunnyvale, CA (US)

(21) Appl. No.: 13/782,063

(22) Filed: Mar. 1, 2013

(51) Int. Cl. G06F 9/54

(52) U.S. Cl. CPC G06F 9/542
USPC 719/318

(57) ABSTRACT

The described embodiments include a computing device. In these embodiments, an entity in the computing device receives an identification of a memory location and a condition to be met by a value in the memory location. Upon a predetermined event occurring, the entity causes an operation to be performed when the value in the memory location meets the condition.

### RELATED APPLICATION

The instant application is related to U.S. patent application Ser. No. ______, which is titled “Conditional Notification Mechanism,” by inventors Steven K. Reinhardt, Marc S. Orr, and Bradford M. Beckmann, which was filed ______, and for which the attorney docket no. is 6872-120422. The instant application is related to U.S. patent application Ser. No. ______, which is titled “Conditional Notification Mechanism,” by inventors Steven K. Reinhardt, Marc S. Orr, and Bradford M. Beckmann, which was filed 1 Mar. 2013, and for which the attorney docket no. is 6872-120423.

### BACKGROUND

1. Field

The described embodiments relate to computing devices. More specifically, the described embodiments relate to a conditional notification mechanism for computing devices.

2. Related Art

Many modern computing devices include two or more entities such as central processing units (CPU) or a graphics processing unit (GPU) cores, hardware thread contexts, etc. In some cases, two or more entities in a computing device need to communicate with one another to determine if a given event has occurred. For example, a first CPU core may reach a synchronization point at which the first CPU core communicates with a second CPU core to determine if the second CPU core has reached a corresponding synchronization point. Several techniques have been proposed to enable entities in a computing device to communicate with one another to determine if a given event has occurred, as described below.

A first technique for communicating between entities is a “polling” technique for which a first entity, until a value in a shared memory location meets a condition, reads the shared memory location and determines if the shared memory location meets the condition. For this technique, a second (and perhaps third, fourth, etc.) entity updates the shared memory location when a designated event has occurred (e.g., when the second entity has reached a synchronization point). This technique is inefficient in terms of power consumption because the first entity is obligated to fetch and execute instructions for performing the reading and determining operations. Additionally, this technique is inefficient in terms of cache traffic because the reading of the shared memory location can require invalidation of a cached copy of the shared memory location. Moreover, this technique is inefficient because the polling entity is using computational resources that could be used for performing other computational operations.

A second technique for communicating between entities is an interrupt scheme, in which an interrupt is triggered by a first entity in order to communicate with a second (and perhaps third, fourth, etc.) entity. This technique is inefficient because processing interrupts in the computing device requires numerous operations be performed. For example, in some computing devices, it is necessary to flush instructions from one or more pipelines and save state before an interrupt handler can process the interrupt. In addition, in some computing devices, processing an interrupt requires communicating the interrupt to an operating system on the computing device for prioritization and may require invoking scheduling mechanisms (e.g., a thread scheduler, etc.).

A third technique for communicating between entities is the use of instructions such as the MONITOR and MWAIT instructions. For this technique, a first entity executes the MONITOR instruction to configure a cache coherency mechanism in the computing device to monitor for updates to a designated memory location. Upon then executing the MWAIT instruction, the first entity signals the coherency mechanism (and the computing device generally) that it is transitioning to a wait (idle) state until an update (e.g., a write) is made to the memory location. When a second entity updates the memory location by writing to the memory location, the coherency mechanism recognizes that the update has occurred and forwards a wake-up signal to the first entity, causing the first entity to exit the idle state. This technique is useful for simple cases where a single update is made to the memory location. However, when a value in the memory location is to meet a condition, the technique is inefficient. For example, assuming that the condition is that the memory location, which starts at a value of 0, is to be greater than 25, and that the second entity increases the value in the memory location by at least one each time an event occurs. In this case, the first entity may be obligated to execute the MONITOR/MWAIT instructions and conditional checking instructions as many as 26 times before the value in the memory location meets the condition.

A fourth technique for communicating between entities employs a user-level interrupt mechanism where a first entity specifies the address of a memory location (“flag”). When a second entity subsequently updates/sets the flag, the first entity is signaled to execute an interrupt handler. For this technique, much of the control for handling the communication between the entities is passed to software and thus to the programmer. Because software is used for handling the communication between the entities, technique is inefficient and error-prone.

As described above, the various techniques that have been proposed to enable entities to communicate with one another to determine if a given event has occurred are inefficient in one way or another.

### SUMMARY

The described embodiments include a computing device. In these embodiments, an entity in the computing device receives an identification of a memory location and a condition to be met by a value in the memory location. Upon a predetermined event occurring, the entity causes an operation to be performed when the value in the memory location meets the condition.

In some embodiments, before the predetermined event occurs, the entity is configured to transition at least one circuit from a higher-power mode to a lower-power mode. In these embodiments, performing the operation comprises transitioning the at least one circuit from the lower-power mode to the higher-power mode. In some of these embodiments, the entity is configured to determine whether the value in the memory location meets the condition upon the predetermined event occurring by determining whether the value in the memory location meets the condition without first transitioning the at least one circuit from the lower power operating mode to the higher power operating mode.

In some embodiments, when receiving the condition to be met by the value in the memory location, the entity is configured to receive a test value and a conditional test to be performed to determine if the value in the memory location has a corresponding relationship to the test value. In some embodiments, the relationship to the test value comprises at least one of: greater than, less than, equal to, and not equal to.

In some embodiments, when receiving the condition to be met by the value in the memory location, the entity is configured to receive a conditional test to be performed to determine if the value in the memory location changed in a given way with regard to at least one prior value in the memory location.

In some embodiments, the predetermined event occurs when the value in the memory location is changed or invalidated.

In some embodiments, the entity is configured to determine whether the value in the memory location meets the condition by: (1) executing microcode that performs one or more operations to determine if the value in the memory location meets the condition, or (2) performing one or more operations in a circuit that is configured to determine if the value in the memory location meets the condition.

In some embodiments, the entity is configured to load a first copy of the value in the memory location to a local cache. Upon receiving an invalidation message identifying the memory location in the local cache (the invalidation message functioning as the predetermined event), the entity is configured to invalidate the first copy of the value in the memory location in the local cache. After invalidating the first copy, the entity is configured to load a second copy of the value in the memory location to the local cache and determine whether the second copy of the value in the memory location in the local cache meets the condition.

Some embodiments receive a task to be performed in the computing device and place the task in a task queue, the task queue including zero or more other tasks that were previously placed in the task queue. Upon placing the task in the task queue, these embodiments increment a task counter, the incrementing of the task counter functioning as the predetermined event and the task counter functioning as the value in the memory location. In these embodiments, the entity determines whether the value in the memory location meets the condition by determining whether the task counter exceeds a predetermined value. When the task counter exceeds the predetermined value, the entity schedules (or initiates) at least one task in the task queue in the computing device.

### BRIEF DESCRIPTION OF THE FIGURES

FIG. 1 presents a block diagram illustrating a computing device in accordance with some embodiments.

FIG. 2 presents a block diagram illustrating a MONITORC instruction in accordance with some embodiments.

FIG. 3 presents a block diagram illustrating a MWAITC instruction in accordance with some embodiments.

FIG. 4 presents a diagram illustrating communications between entities in a computing device in accordance with some embodiments.

FIG. 5 presents a diagram illustrating communications between entities in a computing device in accordance with some embodiments.

FIG. 6 presents a flowchart illustrating a process for monitoring a memory location in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

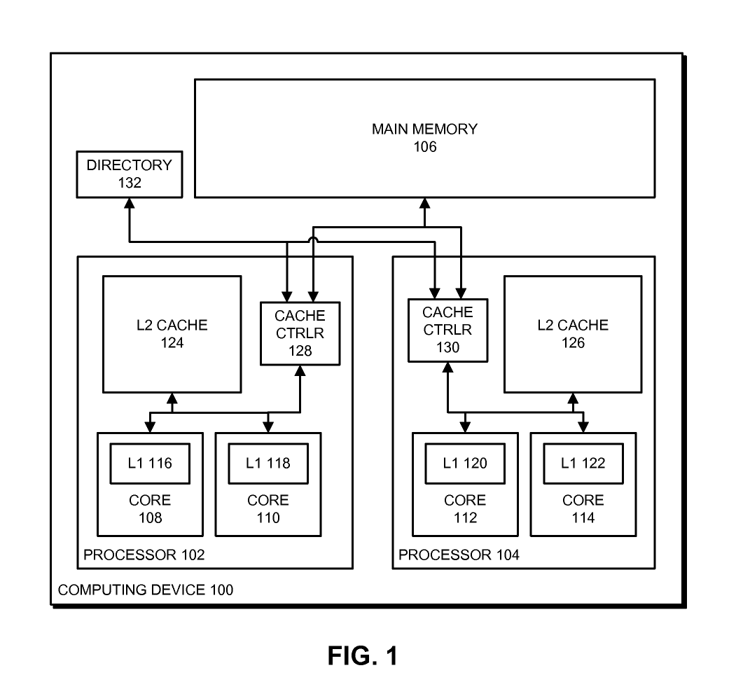

In some embodiments, a computing device (e.g., computing device 100 in FIG. 1) uses code and/or data stored on a computer-readable storage medium to perform some or all of the operations herein described. More specifically, the computing device reads the code and/or data from the computer-readable storage medium and executes the code and/or uses the data when performing the described operations.

A computer-readable storage medium can be any device or medium or combination thereof that stores code and/or data for use by a computing device. For example, the computer-readable storage medium can include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/processor cores/central processing units (CPUs), application-specific integrated circuit (ASIC) chips, field-programmable gate arrays (FPGAs), caches/cache controllers, embedded processors, graphics processors (GPUs)/graphics processor cores, pipelines, and/or other programmable-logic devices. When such hardware modules are activated, the hardware modules perform some or all of the operations. In some embodiments, the hardware modules include one or more general-purpose circuits that are configured by executing instructions (program code, firmware/microcode, etc.) to perform the operations.

In some embodiments, a data structure representative of some or all of the structures and mechanisms described herein (e.g., some or all of computing device 100 (see FIG. 1), directory 132, a processor core, etc. and/or some portion thereof) is stored on a computer-readable storage medium that includes a database or other data structure which can be read by a computing device and used, directly or indirectly, to fabricate hardware comprising the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates/circuit elements from a synthesis library that represent the functionality of the hardware comprising the above-described structures and mechanisms. The netlist may then be placed and routed to produce a data set describing geometric shapes to be applied to masks. The masks may then be used in various semiconductor fabrication steps to produce a semiconductor circuit or circuits corresponding to the above-described structures and mechanisms. Alternatively, the database on the computer accessible storage medium may be the netlist (with or without the synthesis library) or the data set, as desired, or Graphic Data System (GDS) II data.

In the following description, functional blocks may be referred to in describing some embodiments. Generally, functional blocks include one or more interrelated circuits that perform the described operations. In some embodiments, the circuits in a functional block include circuits that execute program code (e.g., machine code, firmware, etc.) to perform the described operations.

### Overview

The described embodiments include mechanisms to enable a first entity in a computing device (where the first entity is e.g., a processor core, a hardware thread context, etc.) to indicate to a second entity (where the second entity is e.g., a processor core, a hardware thread context, a directory, a monitoring mechanism, etc.) when a memory location is to be monitored to determine when a value in the memory location meets a condition. Upon receiving the indication, the second entity monitors the memory location to determine when the memory location meets the condition. When the memory location meets the condition, the second entity sends a signal to the first entity. The signal causes the first entity to perform a corresponding action.

In some embodiments, the condition in the indication sent from the first entity comprises: (1) a test value and (2) a conditional test to be performed to determine if a value in the memory location has a corresponding relationship to the test value (e.g., greater than, equal to, not equal to, less than, etc.). As an example, the message may include a test value of 28 and an indication that a conditional test should be performed to determine if the memory location holds a value that is greater than or equal to the test value.

In some embodiments, the condition in the indication sent from the first entity comprises a test to determine if the value in the memory location changed in a given way with regard to at least one prior value in the memory location. As an example, the conditional test can include a test to determine if the value has increased, decreased, reached a certain proportion of the at least one prior value, etc.

In some embodiments, the mechanism to enable the first entity in the computing device to indicate to the second entity that the memory location is to be monitored comprises a combination of a MONITORC (“monitor conditional”) instruction and a MWAITC (“wait conditional”) instruction. In these embodiments, when executed by the first entity, the MONITORC instruction configures the second entity to monitor a memory location indicated in the MONITORC instruction to determine when the memory location meets a condition indicated in the MONITORC instruction. When executed by the first entity, the MWAITC instruction causes the first entity to enter a first power mode (e.g., an idle or powered-down mode) until the signal indicating that the memory location meets the condition is received from the second entity. In these embodiments, upon receiving the signal from the second entity, the first entity may perform at least part of the corresponding action by transitioning from the first power mode to a second power mode (e.g., an active or full-power mode).

In some embodiments, a third entity monitors a memory location that is modified by the second entity to determine when the memory location meets a condition on behalf of the first entity. For example, in some embodiments, a third entity is a directory associated with a memory. In these embodiments, the first entity communicates the memory location and the condition to the directory and the directory stores the memory location and condition. The second entity then loads data from the memory location into a local cache for the second entity in an exclusive coherency state (e.g., a coherency state in which the data from the memory location in the local cache in the second processor core can be modified by the second processor core). Based on the stored memory location and condition, the directory determines that the second entity loaded the data from the memory location and subsequently causes the second processor core to write the modified data back to the memory location in the memory. After the data is written back by the second processor core, the directory determines if the memory location meets the condition. If so, the directory sends the signal to the first processor core to notify the first processor core that the memory location meets the condition.

In some embodiments, two or more entities may indicate to the second entity when one or more respective memory location is to be monitored to determine when a value in the memory location meets one or more respective conditions. In these embodiments, the second entity may be monitoring two or more memory locations at a time. The second entity monitors the memory location(s) to determine when the memory location meets the condition(s). When the memory location(s) meets the condition(s), the second entity sends a signal to the respective entity as described above. In some embodiments, the second entity includes one or more mechanism for keeping track of which memory location/condition is being monitored for the other entities.

### Computing Device

FIG. 1 presents a block diagram illustrating a computing device 100 in accordance with some embodiments. As can be seen in FIG. 1, computing device 100 includes processors 102-104 and main memory 106. Processors 102-104 are generally devices that perform computational operations in computing device 100. Processors 102-104 include four processor cores 108-114, each of which includes a computational mechanism such as a central processing unit (CPU), a graphics processing unit (GPU), and/or an embedded processor.

Processors 102-104 also include cache memories (or “caches”) that can be used for storing instructions and data that are used by processor cores 108-114 for performing computational operations. The caches in processors 102-104 include a level-one (L1) cache 116-122 (e.g., “L1 116”) in each processor core 108-114 that is used for storing instructions and data for use by the corresponding processor core. Generally, L1 caches 116-122 are the smallest of a set of caches in computing device 100 and are located closest to the circuits (e.g., execution units, instruction fetch units, etc.) in the respective processor cores 108-114. The closeness of the L1 caches 116-122 to the corresponding circuits enables the fastest access to the instructions and data stored in the L1 caches 116-122 from among the caches in computing device 100.

Processors 102-104 also include level-two (L2) caches 124-126 that are shared by processor cores 108-110 and 112-114, respectively, and hence are used for storing instructions and data for all of the sharing processor cores. Generally, L2 caches 124-126 are larger than L1 caches 116-122 and are located outside, but close to, processor cores 108-114 on the same semiconductor die as processor cores 108-114. Because L2 caches 124-126 are located outside the corresponding processor cores 108-114, but on the same die, access to the instructions and data stored in L2 cache 124-126 is slower than accesses to the L1 caches.

Each of the L1 caches 116-122 and L2 caches 124-126, (collectively, “the caches”) include memory circuits that are used for storing cached data and instructions. For example, the caches can include one or more of static random access memory (SRAM), embedded dynamic random access memory (eDRAM), DRAM, double data rate synchronous DRAM (DDR SDRAM), and/or other types of memory circuits.

Main memory 106 comprises memory circuits that form a “main memory” of computing device 100. Main memory 106 is used for storing instructions and data for use by the processor cores 108-114 on processor 102-104. In some embodiments, main memory 106 is larger than the caches in computing device 100 and is fabricated from memory circuits such as one or more of DRAM, SRAM, DDR SDRAM, and/or other types of memory circuits.

Taken together, L1 caches 116-122, L2 caches 124-126, and main memory 106 form a “memory hierarchy” for computing device 100. Each of the caches and main memory 106 are regarded as levels of the memory hierarchy, with the lower levels including the larger caches and main memory 106. Within computing device 100, memory requests are preferentially handled in the level of the memory hierarchy that results in the fastest and/or most efficient operation of computing device 100.

In addition to processors 102-104 and memory 106, computing device 100 includes directory 132. In some embodiments, processor cores 108-114 may operate on the same data (e.g., may load and locally modify data from the same locations in memory 106). Computing device 100 generally uses directory 132 to avoid different caches (and memory 106) holding copies of data in different states—to keep data in computing device 100 “coherent.” Directory 132 is a functional block that includes mechanisms for keeping track of cache blocks/data that are held in the caches, along with the coherency state in which the cache blocks are held in the caches (e.g., using the MOESI coherency states modified, owned, exclusive, shared, invalid, and/or other coherency states). In some embodiments, as cache blocks are loaded from main memory 106 into one of the caches in computing device 100 and/or as a coherency state of the cache block is changed in a given cache, directory 132 updates a corresponding record to indicate that the data is held by the holding cache, the coherency state in which the cache block is held by the cache, and/or possibly other information about the cache block (e.g., number of sharers, timestamps, etc.). When a processor core or cache subsequently wishes to retrieve data or change the coherency state of a cache block held in a cache, the processor core or cache checks with directory 132 to determine if the data should be loaded from main memory 106 or another cache and/or if the coherency state of a cache block can be changed.

In addition to operations related to maintaining data in a coherent state, in some embodiments, directory 132 performs operations for enabling communications between entities in computing device 100 when a memory location meets a condition. For example, in some embodiments, directory 132 generates and/or forwards messages from entities requesting to load cache blocks to other entities. In addition, in some embodiments, directory 132 performs operations for monitoring the memory location to determine when the memory location meets a condition. These operations are described in more detail below.

As can be seen in FIG. 1, processors 102-104 include cache controllers 128-130 (“cache ctrlr”), respectively. Each cache controller 128-130 is a functional block with mechanisms for handling accesses to main memory 106 and communications with directory 132 from the corresponding processor 102-104.

Although an embodiment is described with a particular arrangement of processors and processor cores, some embodiments include a different number and/or arrangement of processors and/or processor cores. For example, some embodiments have only one processor core (in which case the caches are used by the single processor core), while other embodiments have two, six, eight, or another number of processor cores—with the cache hierarchy adjusted accordingly. Generally, the described embodiments can use any arrangement of processors and/or processor cores that can perform the operations herein described.

Additionally, although an embodiment is described with a particular arrangement of caches, some embodiments include a different number and/or arrangement of caches. For example, the caches (e.g., L1 caches 116-122, etc.) can be divided into separate instruction and data caches. Additionally, L2 cache 124 may not be shared in the same way as shown, and hence may only be used by a single processor core, two processor cores, etc. (and hence there may be multiple L2 caches 124 in each processor 102-104). As another example, some embodiments include different levels of caches, from only one level of cache to multiple levels of caches, and these caches can be located in processors 102-104 and/or external to processor 102-104. For example, some embodiments include one or more L3 caches (not shown) in the processors or outside the processors that is used for storing data and instructions for the processors. Generally, the described embodiments can use any arrangement of caches that can perform the operations herein described.

Additionally, although computing device is described using cache controllers 128-130 and directory 132, in some embodiments, one or more of these elements is not used. For example, in some embodiments, one or more of the caches includes mechanisms for performing the operations herein described. In addition, cache controllers 128-130 and/or directory 132 may be located elsewhere in computing device.

Moreover, although computing device 100 and processors 102-104 are simplified for illustrative purposes, in some embodiments, computing device 100 and/or processors 102-104 include additional mechanisms for performing the operations herein described and other operations. For example, computing device 100 and/or processors 102-104 can include power controllers, mass-storage devices such as disk drives or large semiconductor memories (as part of the memory hierarchy), batteries, media processors, input-output mechanisms, communication mechanisms, networking mechanisms, display mechanisms, etc.

### Entities in a Computing Device

In this description, “entities” that communicate a memory location and a condition that the memory location is to meet, that monitor a memory location to determine when the memory location meets a condition, and/or that communicate when the memory location meets the condition are used to describe some embodiments. Generally, an entity can include any portion of computing device 100 that may be configured to monitor memory locations and/or communicate as described. For example, an entity may include one or more CPU or GPU cores, hardware thread contexts, functional blocks or dedicated hardware, etc.

### Lower-Power and Higher-Power Operating, Modes

As described herein, entities in some embodiments may transition from a higher-power mode to a lower-power mode, or vice versa. In some embodiments, the lower-power mode comprises any operating mode in which less electrical power and/or computational power is consumed by an entity than in the higher-power mode. For example, the lower-power mode may be an idle mode, in which some or all of a set of processing circuits in the entity (e.g., a computational pipeline in the entity, a processor core, a hardware thread context, etc.) are halted or operating at a reduced rate. As another example, the lower-power mode may be a sleep or powered-down mode where an operating voltage for some or all of the entity is reduced and/or control signals (e.g., clocks, strobes, precharge signals, etc.) for some or all of the entity are slowed or stopped. Note that, in some embodiments, at least a portion of the entity continues to operate in the lower-power mode. For example, in some embodiments, the entity remains sufficiently operable to send and receive signals for communicating between entities and for confirming that the condition is met (using dedicated hardware or microcode) as described herein.

In some embodiments, the higher-power mode comprises any operating mode in which more electrical power and/or computational power is consumed by the entity than in the lower-power mode. For example, the higher-power mode may be an active mode, in which some or all of a set of processing circuits in the entity (e.g., a computational pipeline, a processor core, a hardware thread context, etc.) are operating at a typical/normal rate. As another example, the higher-power mode may be an awake/normal mode in which an operating voltage for some or all of the entity is set to a typical/normal voltage and/or control signals (e.g., clocks, strobes, precharge signals, etc.) for some or all of the entity are operating at typical/normal rates.

### MONITORC and MWAITC Instructions

Some embodiments include a MONITORC (“monitor conditional”) instruction that enables a first entity in a computing device to communicate to a second entity when a memory location is to be monitored to determine when a value in the memory location meets a condition. Some of these embodiments also include a MWAITC (“wait conditional”) instruction that, when executed by the first entity, causes the first entity to enter a lower-power mode to await a signal from the second entity when the memory location meets the condition. Generally, these instructions are executed by the first entity as part of executing program code, and cause the first entity and a second entity to perform the operations herein described.

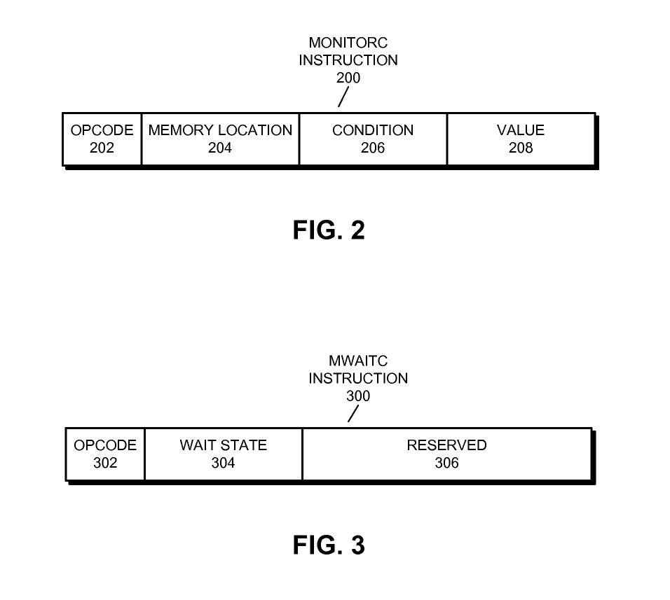

FIG. 2 presents a block diagram illustrating a MONITORC instruction 200 in accordance with some embodiments. As shown in FIG. 2, the MONITORC instruction 200 comprises opcode 202, memory location 204, condition 206, and value 208. Opcode 202 is a multi-bit code configured to enable various functional blocks (e.g., a decode unit and/or an execution unit in a computational pipeline) in the first entity to identify the instruction as the MONITORC instruction, and hence to determine a format of the instruction and how to execute the instruction.

Memory location 204 comprises an indication of a memory location to be monitored. For example, in some embodiments, memory location 204 includes a starting address and an ending address of a range of addresses to be monitored, where the range of addresses can be any size for which a change within the range (e.g., to one or more bits, bytes, words, etc.) can be detected. As another example, in some embodiments, the size of the memory location is fixed and memory location 204 comprises the starting address of the memory location. Note that, although “memory locations” are discussed herein, in some embodiments, the second entity (i.e., the entity that monitors the memory location) monitors a cache block (where a “cache block” comprises some or all of one or more cache lines) in which a copy of data from the memory location indicated in the MONITORC instruction is stored.

Condition 206 comprises an indication of the condition that it is to be determined if the memory location indicated by memory location 204 meets. Generally, the condition can be any condition that can be determined by the second entity using one or more comparisons (greater than, less than, equal, etc.), mathematical operations (add, subtract, min/max, etc.), logical operations (AND, OR, etc.), bitwise operations, etc. For example, the condition can be whether a value in the memory location is greater than or equal to half of a value of a number N. In some embodiments, the condition is encoded using an identifier such as a pattern of bits or a number. For example, the identifier may be 0010 or 13 for a condition such as “less than,” etc. In these embodiments, the second entity includes one or more mappings (tables, etc.) that enables the translation of the identifier for the condition into the actual condition that the memory location is to be determined to meet.

Value 208 comprises a value that can be used with condition 206 in determining if the memory location meets the condition. Generally, the value may be any value that can be used in making the determination if the memory location meets the condition. For example, signed and unsigned integer and floating point values, characters, bit patterns, etc. As one example, in some embodiments, using the value, a condition such as whether a value in the memory location is less than a value M, where M is a unsigned integer, can be used.

In some embodiments, condition 206 encodes the entire condition and hence value 208 is unused (or may be used to carry other information for the MONITORC instruction). As some examples, in some of these embodiments, condition 206 may be whether the memory location is non-zero/zero, is even or odd, etc. In some embodiments, although a value is used with condition 206, the value is a prior value of the memory location (and hence value 208 is not used). In these embodiments, after receiving the indication that the memory location is to be monitored to determine when a value in the memory location meets a condition, the second entity records/captures a value in the memory location as a prior value. For example, the second entity can record/capture a value immediately upon receiving the indication or at some time after receiving the indication, such as after the memory location has been updated one or more times, etc. The prior value can then be used with condition 206 similarly to how value 208 is used with condition 206.

FIG. 3 presents a block diagram illustrating a MWAITC instruction 300 in accordance with some embodiments. As shown in FIG. 3, the MWAITC instruction 300 comprises opcode 302, wait state 304, and reserved 306. Opcode 302 is a multi-bit code configured to enable various functional blocks (e.g., a decode unit and/or an execution unit in a computational pipeline) in the first entity to identify the instruction as the MWAITC instruction, and hence to determine a format of the instruction and how to execute the instruction.

Wait state 304 includes an indication of a power mode that should be entered by the first entity to await a signal from the second entity when the memory location meets the condition. In some embodiments, the indication may be ignored by the second entity, and the entity that executed the MWAITC instruction may continue to process instructions following the MWAITC instruction without entering the power mode indicated by wait state 304.

Reserved 306 is reserved for future implementations of the MWAITC instruction.

In some embodiments, when executed by a first entity, MONITORC instruction 200 causes the first entity to signal the second entity that the memory location indicated in memory location 204 is to be monitored to determine if the memory location meets the condition indicated in condition 206. Depending on the condition, the value 208 may also be signaled to the second entity. In some embodiments, “signaling” the second entity the memory location, the condition, and/or the value comprises storing the memory location, condition, and/or value in one or more memory elements (e.g., in registers, at addresses in memory, etc.) and sending a predetermined signal (e.g., setting a flag, asserting a signal on a signal line, sending a message, etc.) to the second entity to indicate that a memory location should be monitored. In these embodiments, the second entity acquires the memory location, the condition, and/or the value from the memory elements.

In some embodiments, when executed by the first entity, the MWAITC instruction 300 optionally causes the first entity to enter a first power mode. For example, the MWAITC instruction 300 may cause the first entity to enter a lower-power operating mode such as an idle or powered-down mode. In these embodiments, the first entity remains in the first power mode until a wakeup signal is received from the second entity. The second entity sends the wakeup signal when the memory location meets the condition.

Although various fields (i.e., opcode 202, memory location 204, opcode 302, reserved 306, etc.) are used in describing the MONITORC instruction 200 and the MWAITC instruction 300, in some embodiments, the fields (and the corresponding values) may be different. Generally, the MONITORC and MWAITC instructions can comprise any fields/value(s) that can be used to determine if a memory location meets a condition and/or to perform the operations herein described.

In addition, although the MONITORC instruction 200 is described above as containing the memory location, the condition, and the value (such as with an “immediate” type instruction), in some embodiments, one or more of the memory location, the condition, and the value are stored in memory elements that are accessed by the first and/or second entity to store and/or acquire the values. The same is true for the MWAITC instruction in some embodiments. In these embodiments, the MONITORC and/or MWAITC instructions include an indication of the memory element where the values are stored (e.g., register addresses, addresses in memory, etc.).

Moreover, although various operations are used in describing the functions performed by the MONITORC and MWAITC instructions, in some embodiments, the MONITORC and MWAITC instructions use different operations for performing the functions and/or perform the operations in a different order. Generally, the MONITORC and MWAITC instructions can perform any operation(s) that enable the functions herein described.

### Communicating Between Entitles

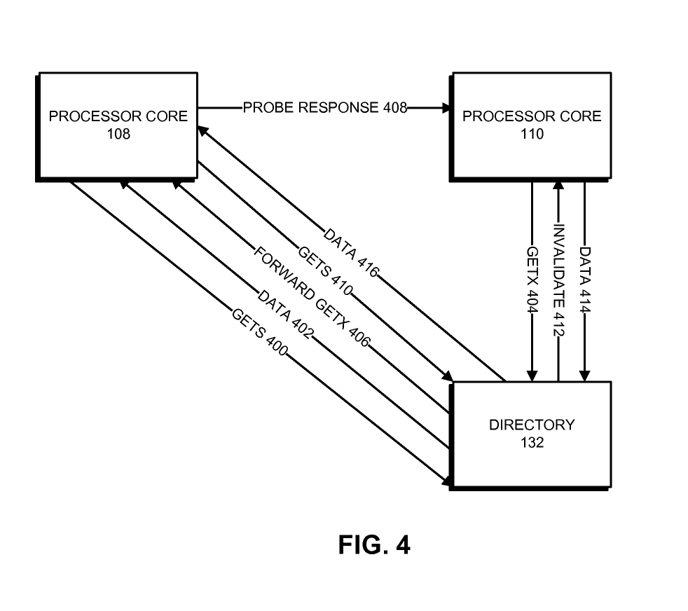

FIG. 4 presents a diagram illustrating communications between entities in computing device 100 in accordance with some embodiments. For the example in FIG. 4, the entities are processor cores 108 and 110 and directory 132, and a cache block that includes a copy of the memory location that is to be monitored is stored in a local cache in the processor cores (e.g., L1 caches 116 and 118). Note that the operations and communications/messages shown in and described for FIG. 4 are presented as a general example of operations and communications/messages used in some embodiments. The operations performed by other embodiments include different operations and/or operations that are performed in a different order and the communications/messages may be different. Additionally, although certain mechanisms in computing device 100 are used in describing the process, in some embodiments, other mechanisms can perform the operations.

The process shown in FIG. 4 starts when processor core 108 prepares to enter a lower-power mode. As part of the preparation, processor core 108 sends GETS 400 to load a memory location that is to be monitored to a cache block (e.g., a cache line or another portion of the cache) in L1 cache 116 in a shared coherency state. Upon receiving GETS 400, directory 132 performs operations (e.g., invalidations, coherency updates, etc.) to get shared permission for the memory location and then sends data 402 from the memory location to processor core 108 to be stored in L1 cache 116 in the shared coherency state.

After storing data 402 to the cache block in L1 cache 116, processor core 108 executes a MONITORC instruction 200 that configures a monitoring mechanism on processor core 108 (which is the second entity, but which is not shown for clarity) to monitor the memory location to determine when the memory location meets a condition. As described above, this operation comprises communicating a memory location to be monitored that is based on memory location 204 in the MONITORC instruction 200, a condition that is based on condition 206 in the MONITORC instruction 200, and possibly (depending on the condition) a value that is based on value 208 in the MONITORC instruction 200 to the monitoring mechanism on processor core 108. For example, in some embodiments, condition 206 includes an indication that a conditional test is to be performed to determine if a value in the memory location has a corresponding relationship to a test value from value 208 (e.g., greater than, equal to, not equal to, less than, etc.). As another example, in some embodiments, condition 206 may include an indication that a conditional test is to be performed to determine if the value in the memory location changed in a given way with regard to at least one prior value in the memory location. After executing the MONITORC instruction 200, processor core 108 executes a MWAITC instruction 300, which causes processor core 108 to enter a lower-power mode as directed by wait state 304 in the MWAITC instruction 300 (the lower-power mode is described above).

Next, processor core 110 sends GETX 404 to directory 132 to load the memory location to a cache block in L1 cache 118 in an exclusive coherency state. Because processor core 108 holds the copy of the memory location in the shared state, directory 132 forwards GETX 404 to processor core 108 as forward GETX 406 (which indicates the memory location and that GETX 404 came from processor core 110). Upon receiving forward GETX 406, processor core 108 sends probe response 408, which includes the data requested by processor core 110, to processor core 110. Upon receiving probe response 408, processor core 110 stores the data to a cache block in L1 cache 118 for the memory location in the exclusive coherency state. Processor core 110 can then modify the value of the cache block (e.g., writes a new value to the cache block), but does not have to modify the value of the cache block.

After sending probe response 408 to processor core 110 (and because the data in the copy of the memory location in L1 cache 118 may have been modified), processor core 108 sends GETS 410 to load a memory location that is being monitored to a cache block (e.g., a cache line or another portion of the cache) in L1 cache 116 in a shared coherency state. Upon receiving GETS 400, directory 132 performs operations (e.g., sends invalidate 412 to processor core 110 to invalidate the copy of the cache line in L1 cache 118, etc.) to get shared permission (and the possibly modified data 414) for the memory location and then sends the data 416 from the memory location to processor core 108 to be stored in L1 cache 116 in the shared coherency state.

Upon receiving data 416, processor core 108 stores data 416 to a cache block in L1 cache 116 for the memory location in the shared coherency state. The monitoring mechanism on processor core 108 then determines if the memory location meets the condition. For example, the monitoring mechanism can execute microcode that performs the operations to determine if the memory location meets the condition based on the condition (and possibly value) earlier communicated to the monitoring mechanism and/or can use a dedicated hardware mechanism such as logic circuits or other functional blocks to perform the check. For example, if the condition is “greater than or equal to” and the value is 12, the monitoring mechanism can determine if a value in the memory location is greater than or equal to 12. As another example, if the condition is “is non-zero,” the monitoring mechanism can determine if a value in the memory location is non-zero. If the memory location meets the condition, the monitoring mechanism can “wake up” processor core 108. For example, monitoring mechanism can send a signal to processor core 108 that causes processor core 108 to transition from the lower-power mode to a higher-power mode (the higher-power mode is described above). Otherwise, if the memory location does not meet the condition, monitoring mechanism continues to monitor the memory location (and may leave processor core 108 in the lower-power mode).

In the embodiment shown in FIG. 4, the MONITORC instruction 200 and the MWAITC instruction 300 are used to configure a monitoring mechanism in processor core 108 to monitor the memory location to determine when the memory location meets the condition. In these embodiments, the condition is checked (e.g., using the microcode and/or in a dedicated circuit) without restoring processor core 108 to the higher-power mode. This is an improvement over the above-described MONITOR and MWAIT instructions, for which processor core 108 must be restored to the higher-power mode to enable the determination of whether the memory location meets the condition (because user-level software must perform the check).

Although a separate monitor mechanism is described in processor core 108, in some embodiments, the monitor mechanism is part of (i.e., is incorporated in) another mechanism (or mechanisms) in processor core 108. For example, in some embodiments, the microcode (which may be program code stored in a dedicated memory element in processor core 108) can be executed using a computational pipeline in processor core 108. Generally, processor core 108 can use any combination of mechanisms that enables the checks herein described.

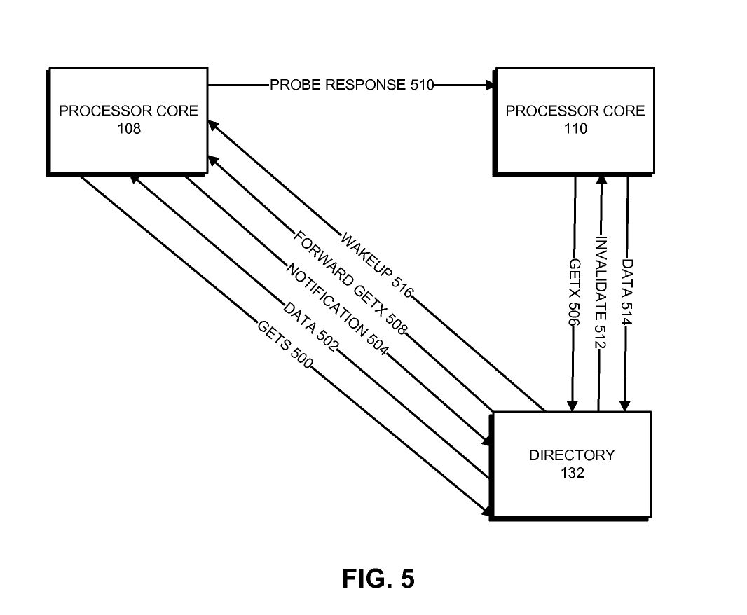

FIG. 5 presents a diagram illustrating communications between entities in computing device 100 in accordance with some embodiments. For the example in FIG. 5, the entities are processor cores 108 and 110 and directory 132, and a cache block that includes a copy of the memory location that is to be monitored is stored in a local cache in the processor cores (e.g., L1 caches 116 and 118). Note that the operations and communications/messages shown in and described for FIG. 5 are presented as a general example of operations and communications/messages used in some embodiments. The operations performed by other embodiments include different operations and/or operations that are performed in a different order and the communications/messages may be different. Additionally, although certain mechanisms in computing device 100 are used in describing the process, in some embodiments, other mechanisms can perform the operations.

The process shown in FIG. 5 differs from the process shown in FIG. 4 in that a monitoring mechanism in directory 132 monitors the memory location to determine when the memory location meets the condition (instead of a monitoring mechanism in processor core 108 such as in FIG. 4).

The process shown in FIG. 5 starts when processor core 108 prepares to enter a lower-power mode. As part of the preparation, processor core 108 sends GETS 500 to load a memory location that is to be monitored to a cache block (e.g., a cache line or another portion of the cache) in L1 cache 116 in a shared coherency state. Upon receiving GETS 500, directory 132 performs operations (e.g., invalidations, coherency updates, etc.) to get shared permission for the memory location and then sends data 502 from the memory location to processor core 108 to be stored in L1 cache 116 in the shared coherency state.

After storing the data to the cache block in L1 cache 116, processor core 108 executes a MONITORC instruction 200 which causes processor core 108 to send notification 504 to directory 132 to cause directory 132 (which is the second entity) to monitor the memory location to determine when the memory location meets a condition. Notification 504 comprises an indication of a memory location to be monitored that is based on memory location 204 in the MONITORC instruction 200, a condition to be monitored for that is based on condition 206 in the MONITORC instruction 200, and possibly (depending on the condition) the value that is based on value 208 the MONITORC instruction 200. For example, in some embodiments, condition 206 includes an indication that a conditional test is to be performed to determine if a value in the memory location has a corresponding relationship to a test value from value 208 (e.g., greater than, equal to, not equal to, less than, etc.). As another example, in some embodiments, condition 206 may include an indication that a conditional test is to be performed to determine if the value in the memory location changed in a given way with regard to at least one prior value in the memory location. After executing the MONITORC instruction 200, processor core 108 executes a MWAITC instruction 300, which causes processor core 108 to enter a lower-power mode as directed by wait state 304 in the MWAITC instruction 300 (the lower-power mode is described above).

Next, processor core 110 sends GETX 506 to directory 132 to load the memory location to a cache block in L1 cache 118 in an exclusive coherency state. Because processor core 108 holds the copy of the memory location in the shared state, directory 132 forwards GETX 506 to processor core 108 as forward GETX 508 (which indicates the memory location and that GETX 506 came from processor core 110). Upon receiving forward GETX 508, processor core 108 sends probe response 510, which includes the data requested by processor core 110, to processor core 110 and sends an acknowledge signal (not shown) to directory 132. Upon receiving probe response 510, processor core 110 stores the data to a cache block in L1 cache 118 for the memory location in the exclusive coherency state. Processor core 110 can then modify the value of the cache block (e.g., write a new value to the cache block), but does not have to modify the value of the cache block.

After receiving the acknowledge signal (and because the data in the copy of the memory location in L1 cache 118 may have been modified), directory 132 sends invalidate 512 to processor core 110 to cause processor core 110 to invalidate the copy of the memory location held in L1 cache 118 (and thus to write the possibly modified data 514 for the memory location back to memory), or otherwise receives data 514 from processor core 110 (i.e., receives the data without directory 132 sending a signal that invalidates the data in L1 cache 118). Directory 132 then determines if the memory location in memory meets the condition. For example, if the condition is “greater than or equal to” and the value is 12, directory 132 can determine if a value in the memory location is greater than or equal to 12. As another example, if the condition is “is non-zero,” directory 132 can determine if a value in the memory location is non-zero. If the memory location meets the condition, directory 132 sends wakeup 516 to processor core 108. Wakeup 516 causes processor core 108 to transition from the lower-power mode to a higher-power mode (the higher-power mode is described above).

Otherwise, if the memory location does not meet the condition, directory 132 continues to monitor the memory location (and may thus leave processor core 108 in the lower-power mode). In some embodiments, to enable the continued monitoring of the memory location, the directory retains/stores the condition so that the condition can be re-checked by again performing at least some of the operations shown in FIG. 5.

In the embodiment shown in FIG. 5, the MONITORC instruction 200 and the MWAITC instruction 300 are used to configure directory 132 to monitor the memory location to determine when the memory location meets the condition. In these embodiments, the condition is checked by directory 132 without restoring processor core 108 to the higher-power mode. This is an improvement over the above-described MONITOR and MWAIT instructions, for which processor core 108 must be restored to the higher-power mode to enable the determination of whether the memory location meets the condition (because user-level software must perform the check).

In some embodiments, directory 132 includes a monitor mechanism (not shown) that is configured to send and receive the above-described communications and to determine if the memory location meets the condition. In some of these embodiments, the monitor mechanism comprises a functional block that may include combinational logic, processing circuits (possibly including some or all of a processor core), and/or other circuits. Generally, directory 132 includes sufficient mechanisms to perform the operations herein described.

The specification/figures and claims in the instant application refer to “first,” “second,” “third,” etc. entities. These labels enable the distinction between different entities in the specification/figures and claims, and are not intended to imply that the operations herein described extend to only two, three, etc. entities. Generally, the operations herein described extend to N entities.

### Processor for Performing a Task and Scheduling Mechanism

In some embodiments, the first entity (i.e., the entity that is to receive the notification when the memory location meets the condition) is a processor core that is configured to perform a task on a batch or set of data. For example, in some embodiments, the first entity is a CPU or GPU processor core that is configured to perform multiple parallel tasks simultaneously (e.g., pixel processing or simultaneous instruction, multiple data operations). In these embodiments, the second entity (i.e., the entity that is to monitor the memory location) is a scheduling mechanism that is configured to monitor available data and to cause the processor core to perform the task when a sufficient batch or set of data is available to use a designated amount of the parallel processing power of the processor core.

In these embodiments, the processor core, upon executing the MONITORC instruction, communicates (as herein described) an identifier for a memory location where a dynamically updated count of available data is stored (e.g., a pointer to a top of a queue of available data, etc.) and a condition that is a threshold for an amount of data that is to be available before the processor core is to begin performing the task on the set of data to the scheduling mechanism. The processor core then executes the MWAITC instruction and transitions to a lower-power mode. Based on the identifier for the memory location, the scheduling mechanism monitors the count of available data to determine when the threshold amount of data (or more) becomes available. When the threshold amount of data (or more) becomes available, the scheduling mechanism sends a signal to the processor core that causes the processor core to wake up and process the available data. In these embodiments, the processor core can inform the scheduling mechanism of the threshold and is not responsible for monitoring the count of available data (which may conserve power, computational resources, etc.).

### Process for Monitoring a Memory Location

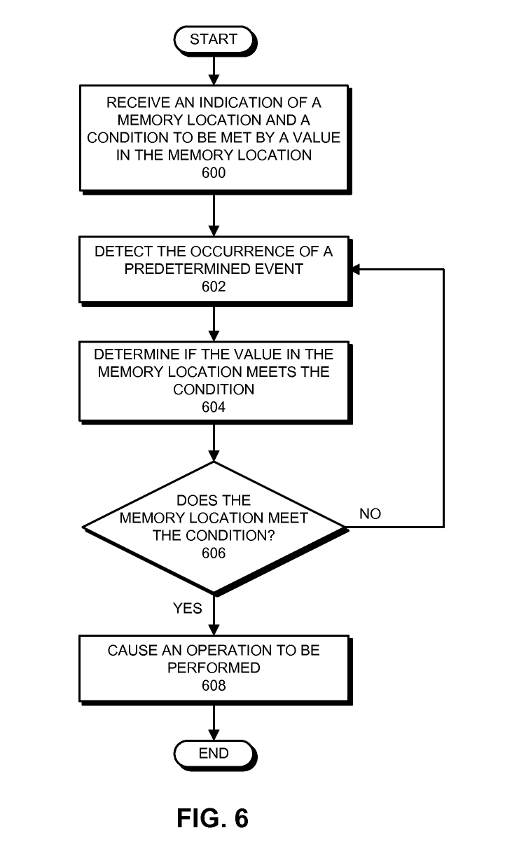

FIG. 6 presents a flowchart illustrating a process for monitoring a memory location in accordance with some embodiments. Note that the operations shown in FIG. 6 are presented as a general example of functions performed by some embodiments. The operations performed by other embodiments include different operations and/or operations that are performed in a different order. Additionally, although certain mechanisms in computing device 100 are used in describing the process, in some embodiments, other mechanisms can perform the operations.

In the following example, the term “entity” is used in describing operations performed by some embodiments. As described above, an entity can include any portion of computing device 100 that may be configured to monitor memory locations and/or communicate as described. For example, an entity can include a CPU or GPU processor core, a monitoring mechanism, a directory, one or more functional blocks, etc.

The process shown in FIG. 6 starts when an entity receives an indication of a memory location and a condition to be met by a value in the memory location (step 600). In these embodiments, the memory location may comprise any portion of memory 106 (or a cache block containing the portion of memory 106) that the entity can monitor to determine if the portion of memory 106 meets the condition. For example, the memory location can comprise one or more bytes, etc. In these embodiments, the condition to be met by memory location can generally include any condition that can be determined by the entity, including conditions that are determined by performing one or more comparisons, mathematical operations, bitwise operations, etc. or combinations thereof. For example, in some embodiments, receiving the condition comprises receiving a test value and a conditional test to be performed to determine if the value in the memory location has a corresponding relationship to the test value, where the relationship to the test value comprises at least one of greater than, less than, and equal to. An example of such a condition is when the test value is 64 and the conditional test is “greater than,” in which case the memory location is tested to determine if a value in the memory location is greater than 64. As another example, in some embodiments, receiving the condition comprises receiving a conditional test to be performed to determine if the value in the memory location changed in a given way with regard to at least one prior value in the memory location. An example of such a condition, is when the conditional test is “increasing,” in which case the memory location is tested to determine if the value in the memory location is increasing with regard to at least one prior value of the memory location.

The entity then detects the occurrence of a predetermined event (step 602). Generally, the predetermined event comprises any one or more events that can be detected by the entity and used as an indication that a determination should be made whether the memory location meets the condition. For example, in some embodiments, the entity can determine that a value in the memory location has changed. As an example of this, consider forward GETX 406 in FIG. 4, which functions to alert processor core 108 (the entity in that example) that the value in the memory location may have been changed.

The entity next determines if the value in the memory location meets the condition (step 604). In other words, the entity performs one or more operations to determine if the above-described condition is met by the memory location. As one example, in embodiments where the test condition is “less than half of” and the text value is computed using a number of waiting instructions in a queue, the entity can perform one or more computations, comparisons, etc. to determine if the value in the memory location is less than half of the number of waiting instructions in the queue.

When the memory location does not meet the condition (step 606), the entity returns to monitoring the memory location. Otherwise, when the memory location meets the condition (step 606), the entity causes an operation to be performed (step 608). For example, in some embodiments, before the predetermined event occurs, computing device 100 transitions at least one circuit from a higher-power mode to a lower-power mode. In these embodiments, when causing the operation to be performed, the entity is configured to cause the at least one circuit to be transitioned from the lower-power mode to the higher-power mode.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for operating a computing device, comprising:
receiving an identification of a memory location and a condition to be met by a value in the memory location; and
upon a predetermined event occurring, causing an operation to be performed when the value in the memory location meets the condition.

2. The method of claim 1, wherein the method further comprises:
before the predetermined event occurs, transitioning at least one circuit from a higher-power mode to a lower-power mode; and
wherein performing the operation comprises transitioning the at least one circuit from the lower-power mode to the higher-power mode.

3. The method of claim 2, further comprising determining whether the value in the memory location meets the condition upon the predetermined event occurring by:
determining whether the value in the memory location meets the condition without first transitioning the at least one circuit from the lower power operating mode to the higher power operating mode.

4. The method of claim 1, wherein receiving the condition to be met by the value in the memory location comprises:
receiving a test value; and
receiving a conditional test to be performed to determine if the value in the memory location has a corresponding relationship to the test value.

5. The method of claim 4, wherein the relationship to the test value comprises at least one of:
greater than;
less than;
equal to; and
not equal to.

6. The method of claim 1, wherein receiving the condition to be met by the value in the memory location comprises:
receiving a conditional test to be performed to determine if the value in the memory location changed in a given way with regard to at least one prior value in the memory location.

7. The method of claim 1, wherein the predetermined event occurs when the value in the memory location is changed or invalidated.

8. The method of claim 1, further comprising determining whether the value in the memory location meets the condition by:
executing microcode that performs one or more operations to determine if the value in the memory location meets the condition; or
performing one or more operations in a circuit that is configured to determine if the value in the memory location meets the condition.

9. The method of claim 1, wherein the method further comprises:
loading a first copy of the value in the memory location to a local cache;
upon receiving an invalidation message identifying the memory location in the local cache, the invalidation message functioning as the predetermined event,
invalidating the first copy of the value in the memory location in the local cache;
loading a second copy of the value in the memory location to the local cache; and
determining whether the second copy of the value in the memory location in the local cache meets the condition.

10. The method of claim 1, wherein the method further comprises:
receiving a task to be performed in the computing device and placing the task in a task queue, the task queue including zero or more other tasks that were previously placed in the task queue;
upon placing the task in the task queue, incrementing a task counter, the incrementing of the task counter functioning as the predetermined event and the task counter functioning as the value in the memory location;
determining whether the value in the memory location meets the condition by determining whether the task counter exceeds a predetermined value; and
when the task counter exceeds the predetermined value, scheduling at least one task in the task queue in the computing device.

11. An apparatus, comprising:
a first entity configured to:
receive an identification of a memory location and a condition to be met by a value in the memory location; and
upon a predetermined event occurring, cause a second entity to perform an operation when the value in the memory location meets the condition.

12. The apparatus of claim 11,
wherein, before the predetermined event occurs, the second entity is configured to transition at least one circuit from a higher-power mode to a lower-power mode; and
wherein causing the second entity to perform the operation comprises causing the second entity to transition the at least one circuit from the lower-power mode to the higher-power mode.

13. The apparatus of claim 12, wherein, when determining whether the value in the memory location meets the condition upon the predetermined event occurring, the first entity is configured to:
determine whether the value in the memory location meets the condition without first causing the second entity to transition the at least one circuit from the lower power operating mode to the higher power operating mode.

14. The apparatus of claim 11, wherein, when receiving the condition to be met by the value in the memory location, the first entity is configured to:
receive a test value; and
receive a conditional test to be performed to determine if the value in the memory location has a corresponding relationship to the test value.

15. The apparatus of claim 14, wherein the relationship to the test value comprises at least one of:
greater than;
less than;
equal to; and
not equal to.

16. The apparatus of claim 11, wherein, when receiving the condition to be met by the value in the memory location, the first entity is configured to:
receive a conditional test to be performed to determine if the value in the memory location changed in a given way with regard to at least one prior value in the memory location.

17. The apparatus of claim 11, wherein the predetermined event occurs when the value in the memory location is changed or invalidated.

18. The apparatus of claim 11, wherein the first entity is configured to determine whether the value in the memory location meets the condition by:
executing microcode that performs one or more operations to determine if the value in the memory location meets the condition; or
performing one or more operations in a circuit that is configured to determine if the value in the memory location meets the condition.

19. The apparatus of claim 11, wherein the first entity is configured to:
load a first copy of the value in the memory location to a local cache;
upon receiving an invalidation message identifying the memory location in the local cache, the invalidation message functioning as the predetermined event,
invalidate the first copy of the value in the memory location in the local cache;
load a second copy of the value in the memory location to the local cache; and
determine whether the second copy of the value in the memory location in the local cache meets the condition.

20. The apparatus of claim 11, wherein the first entity is configured to:
receive a task to be performed in the computing device and placing the task in a task queue, the task queue including zero or more other tasks that were previously placed in the task queue;
upon placing the task in the task queue, increment a task counter, the incrementing of the task counter functioning as the predetermined event and the task counter functioning as the value in the memory location;
determine whether the value in the memory location meets the condition by determining whether the task counter exceeds a predetermined value; and
when the task counter exceeds the predetermined value, schedule at least one task in the task queue in the computing device.

21. A computing device, comprising:
at least one processor core;
a first entity associated with the processor core, the first entity configured to:
receive an identification of a memory location and a condition to be met by a value in the memory location; and
upon a predetermined event occurring, cause a second entity to perform an operation when the value in the memory location meets the condition.
